(19) United States
(12) Patent Application Publication
(10) Pub. No.: US 2019/0293841 A1
(43) Pub. Date: Sep. 26, 2019

(54) MARKER

(71) Applicant: ENPLAS CORPORATION, Kawaguchi-shi, Saitama (JP)

(72) Inventor: Tomohiro SAITO, Kawaguchi-shi, Saitama (JP)

(21) Appl. No.: 16/340,983

(22) PCT Filed: Oct. 19, 2017
(86) PCT No.: PCT/JP2017/037825

§ 371 Date: Apr. 10, 2019

(30) Foreign Application Priority Data
Oct. 27, 2016 (JP) 2016-210979

(51) Int. Cl. G02B 3/08; G06K 19/06

(52) U.S. Cl. CPC G02B 3/08; G06K 19/06037

(57) ABSTRACT

The present invention provides a marker that allows a viewing direction to be determined from a detected image. A marker (100) according to the present invention includes a lens main body (110) including a plurality of lens units (111). The plurality of lens units (111) are arranged successively in a planar direction. Each of the lens units (111) includes, on one surface side of the lens main body, a light-condensing portion (121) and a non-light-condensing portion (122) that are provided along an arrangement direction in which the lens units (111) are arranged successively. The lens main body (110) includes, on the other surface (140) side of the lens main body (110), a plurality of detectable portions (141) that can be detected from the one surface side. A pitch of the plurality of lens units (111) is different from a pitch of the plurality of detectable portions (141).

### TECHNICAL FIELD

The present invention relates to a marker.

### BACKGROUND ART

In the fields of augmented reality (also referred to as “AR” hereinafter), robotics, etc., a so-called visual marker is used to recognize the position, the orientation, and the like of an object. As an example of such a marker, there has been reported a marker that includes a lenticular lens arranged on a black stripe pattern (Patent Literature 1).

The lenticular lens generally is a lens body composed of cylindrical lenses arranged successively. Each of the cylindrical lenses has a structure obtained by dividing a cylinder in the axial direction and has a convex portion extending along the axial direction. In the lenticular lens, the cylindrical lenses are arranged in such a manner that the axial directions thereof are parallel with each other. In the above-described marker, the lenticular lens is arranged on the stripe pattern in such a manner that the axial directions of the cylindrical lenses are parallel with the directions in which the black lines of the stripe pattern extend and the pitch of the cylindrical lenses is different from the pitch of the stripe pattern. With such a configuration, when the marker is recognized visually with a camera or the like from the convex portion side of the lenticular lens, the pattern projected on the lenticular lens is detected as an image that moves or deforms depending on the viewing direction. Accordingly, the viewing direction can be recognized from the detected image, and therefore, the position, the orientation, and the like of the object can be recognized as described above.

### CITATION LIST

### Patent Literature

Patent Literature 1: JP 2012-145559 A

### SUMMARY OF INVENTION

### Technical Problem

However, for example, when the normal line to the plane of the marker is used as a reference, the same image may be detected at the same position in both the case where the viewing direction is inclined at a positive angle relative to the normal line and the case where the viewing direction is inclined at a negative angle relative to the normal line. In this case, even if an image is detected, it may be impossible to determine whether the detected image is an image detected from the viewing direction inclined at the positive angle or an image detected from the viewing direction inclined at the negative angle.

As a method for solving this problem, the following method is conceivable, for example. That is, it is a method using a marker, in which the lenticular lens is arranged on a substrate showing the pattern, and further, a circle is drawn on a region on the substrate other than the region where the lenticular lens is arranged, and a pin (also referred to as a pole) is set at the center of the circle to provide the marker. Regarding the marker, in addition to the detection of an image projected on the lenticular lens, the part of the circle hidden by the pin is detected. By detecting which part of the circle is hidden by the pin as described above, it becomes possible to determine whether the detected image is an image detected from the viewing direction inclined at the negative angle or an image detected from the viewing direction inclined at the positive angle. However, according to such a method, the pin needs to be provided, and this causes the marker as a whole to be thick and also increases the manufacturing cost.

With the foregoing in mind, it is an object of the present invention to provide a marker that allows a viewing direction to be determined from a detected image without using a pin as described above, for example.

### Solution to Problem

In order to achieve the above object, the present invention provides a marker including: a lens main body including a plurality of lens units, wherein the plurality of lens units are arranged successively in a planar direction, each of the lens units includes, on one surface side of the lens main body, a light-condensing portion and a non-light-condensing portion that are provided along an arrangement direction in which the lens units are arranged successively, the lens main body includes, on the other surface side of the lens main body, a plurality of detectable portions that can be detected from the one surface side, and a pitch of the plurality of lens units is different from a pitch of the plurality of detectable portions.

### Advantageous Effects of Invention

As described above, the marker according to the present invention is configured such that each of the lens units includes the light-condensing portion and the non-light-condensing portion. With this configuration, it is possible to determine, for example, whether the viewing direction is inclined at a positive angle relative to the normal line or inclined at a negative angle relative to the normal line.

### BRIEF DESCRIPTION OF DRAWINGS

FIG. 1A is a top view showing an example of the marker according to a first embodiment, and FIG. 1B is a cross-sectional view of the marker shown in FIG. 1A as viewed in the arrow direction of line I-I in FIG. 1A.

FIG. 2A shows schematic diagrams for illustrating, regarding the marker shown in FIG. 1, images that change with inclination of light rays at positive angles.

FIG. 2B shows schematic diagrams for illustrating, regarding the marker shown in FIG. 1, images that change with inclination of light rays at negative angles.

FIG. 3 is a cross-sectional view showing a variation of the marker according to the first embodiment.

FIG. 4 is a cross-sectional view showing another variation of the marker according to the first embodiment.

FIGS. 5A to 5D are top views showing examples of a marker set according to a second embodiment.

FIG. 6 is a cross-sectional view showing an example of a bidirectional visual marker used in the marker set according to the second embodiment.

FIGS. 7A and 7B are cross-sectional views showing a marker according to a comparative embodiment. FIG. 7A shows schematic diagrams for illustrating, regarding the above-described marker, an image that changes with inclination of light rays at positive angles. FIG. 7B shows schematic diagrams for illustrating, regarding the above-described marker, an image that changes with inclination of inclination of light rays at negative angles.

FIGS. 8A to 8C are cross-sectional views showing still other variations of the marker according to the first embodiment.

### DESCRIPTION OF EMBODIMENTS

The marker of the present invention may be configured such that, for example, in the lens unit, the light-condensing portion has a convex surface and the non-light-condensing portion has a planar or concave upper surface.

The marker of the present invention may be configured such that, for example, each of the lens units is a partially deleted cylindrical lens that is a cylindrical lens with part of a convex portion thereof being deleted, and the deleted region in the convex portion is the non-light-condensing portion, and a remaining region in the convex portion is the light-condensing portion.

The marker of the present invention may be configured such that, for example, in the partially deleted cylindrical lens, the deleted region is planar or concave.

The marker of the present invention may be configured such that, for example, a cross section of each of the lens units taken in a thickness direction is such that a ratio (C:NC) between a length (C) of the light-condensing portion in the arrangement direction and a length (NC) of the non-light-condensing portion in the arrangement direction in 1:1 to 3:1.

The marker of the present invention may be configured such that, for example, the ratio (C:NC) between the length (C) of the light-condensing portion and the length (NC) of the non-light-condensing portion is 1:1 to 2:1.

The marker of the present invention may be configured such that, for example, the lens main body has a plurality of recesses on the other surface side of the lens main body, and the detectable portions are provided inside the respective recesses. For example, inside the respective recesses, colored films may be provided as the detectable portions.

The marker of the present invention may be configured such that, for example, the respective lens units have the same surface shape and the same size on the one surface side of the lens main body.

The marker of the present invention may be configured such that, for example, in the lens main body, a pattern is formed by the plurality of detectable portions.

The marker of the present invention may be configured such that, for example, in the lens main body, the detectable portions are lines extending in a direction perpendicular to the arrangement direction, and the pattern is a stripe pattern formed by the lines.

The marker of the present invention may be configured such that, for example, in the lens main body, the other surface side of the lens main body is a plane, and the respective detectable portions are fixed on the plane.

The marker of the present invention may be configured such that, for example, the lens main body is a light-transmitting member.

The marker of the present invention may be configured such that, for example, the lens main body is an integrally molded article of the plurality of lens units.

The marker of the present invention may be configured such that, for example, the lens main body is an injection molded article.

Next, embodiments of the present invention will be described with reference to the drawings. It is to be noted, however, that the present invention is by no means limited or restricted by the following embodiments. In the respective drawings, the same components/portions are given the same reference numerals. In the drawings, the structure of each component/portion may be shown in a simplified form as appropriate for convenience of illustration, and the dimension ratio and the like of each component/portion are not limited to the conditions shown in the drawings.

### First Embodiment

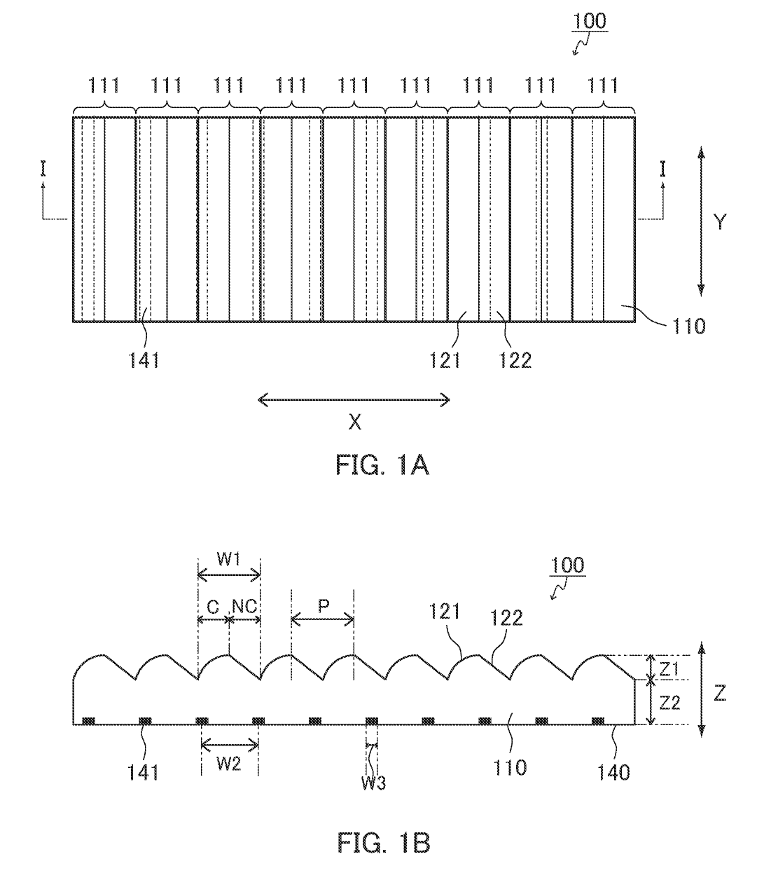

The first embodiment relates to an example of a marker of the present invention. FIGS. 1A and 1B show an example of the marker of the present embodiment. FIG. 1A is a plan view of a marker 100, and FIG. 1B is a cross-sectional view of the marker 100 as viewed in the arrow direction of line I-I in FIG. 1A. In FIG. 1B, hatching representing a cross section is omitted for clarity of illustration. Hereinafter, the same applies to other cross-sectional views.

As shown in FIGS. 1A and 1B, the marker 100 includes a lens main body 110 including a plurality of lens units 111, and the plurality of lens units 111 are arranged successively in the planar direction. The direction in which the plurality of lens units 111 are arranged is referred to as an arrangement direction or a width direction, and is indicated by arrow X in FIGS. 1A and 1B. For convenience of explanation, in FIGS. 1A and 1B, the left side of the arrangement direction X is referred to as upstream and the right side of the arrangement direction X is referred to as downstream. Regarding the marker 100, a direction perpendicular to the arrangement direction X in the planar direction is referred to as a length direction and is indicated by arrow Y in FIG. 1A and a direction perpendicular to the arrangement direction (width direction) X and to the length direction Y is referred to as a thickness direction and is indicated by arrow Z in FIG. 1B.

Each of the lens units 111 includes, on one surface side of the lens main body 110, i.e., on the side of a surface located upward (upper surface) in FIG. 1B, a light-condensing portion 121 and a non-light-condensing portion 122 that are provided along the arrangement direction X. Specifically, the respective lens units 111 include, from the upstream side toward the downstream side of the arrangement direction X, the light collecting units 121 in the same direction and the non-light collecting units 122 in the same direction. As shown in FIG. 1B, in the cross-sectional view taken along the arrangement direction X, the light collecting unit 121 is a region indicated by arrow C and the non-light collecting unit 122 is a region indicated by arrow NC. The lens main body 110 includes a plurality of detectable portions 141 on the other surface side of the lens main body 110, i.e., on the side of a surface 140 located downward (lower surface or rear surface) in FIG. 1B.

The marker of the present invention need only be configured such that, as described above, each of the lens units includes, on one surface side of the lens main body, a light-condensing portion and a non-light-condensing portion that are provided along the arrangement direction in which the lens units are arranged successively, and other configurations are not particularly limited. In the present invention, the light-condensing portion means a surface having a function of condensing light. In the present invention, the non-light-condensing portion may be a surface that exhibits, regarding light condensation, a relatively lower function of condensing light when compared with the light-condensing portion, and preferably is a surface that does not have a function of condensing light.

In each of the lens units 111, the light-condensing portion 121 has a convex surface and the non-light-condensing portion 122 has a planar surface. The shape of the surface of the light-condensing portion 121 and the shape of the surface of the non-light-condensing portion 122 each mean, for example, a surface shape in a cross section taken in the thickness direction Z, and more specifically, a surface shape in a cross section taken in the thickness direction Z along the arrangement direction (width direction) X.

The light-condensing portion 121 need only be capable of condensing light, and for example, the curvature of the convex surface is not particularly limited. In the light-condensing portion 121, the radius of curvature (R) of the convex surface in the cross section taken in the thickness direction increases from the apex of the light-condensing portion 121 toward the lens unit 111 adjacent thereto on the upstream side, for example. The radius of curvature (R) may increase either continuously or intermittently, for example. The radius of curvature at the apex of the light-condensing portion 121 is from 0.25 to 1 mm, for example.

The surface of the non-light-condensing portion 122 is, for example, an inclined planar surface that extends from a downstream end of the light-condensing portion 121 of the same lens unit 111 toward an upstream end portion of a light-condensing portion 121 of an adjacent lens unit 111. The shape of the non-light-condensing portion 122 is not limited to this example. For example, the surface of the non-light-condensing portion 122 may have a non-convex shape in the cross section taken in the thickness direction, and as a specific example, the surface of the non-light-condensing portion 122 may be a concave surface, in addition to the planar surface.

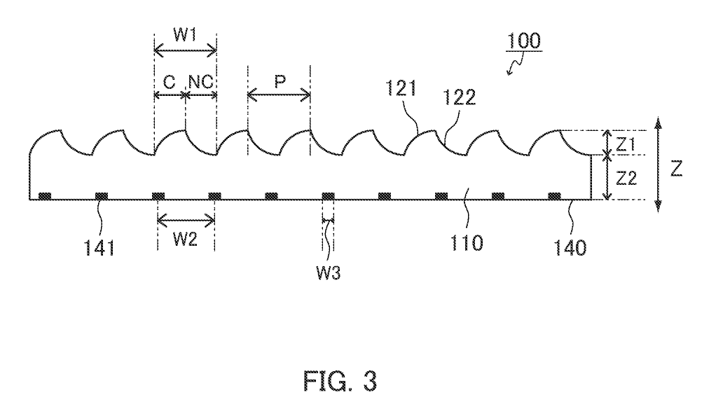

The cross-sectional view of FIG. 3 shows an example of the marker 100 configured such that the non-light-condensing portions 122 are in a concave shape. The surface of each of the non-light-condensing portions 122 is a concave surface that extends from a downstream end of a light-condensing portion 121 of the same lens unit 111 toward an upstream end of a light-condensing portion 121 of an adjacent lens unit 111, for example. The radius of curvature (R) of the concave surface is not particularly limited, and the concave surface is, for example, a curved surface that does not condense light.

The lens unit 111 is, for example, a partially deleted cylindrical lens that is a cylindrical lens with part of a convex portion thereof being deleted. In this case, in the partially deleted cylindrical lens, the deleted region in the convex portion serves as the non-light-condensing portion 122, and the remaining region in the convex portion serves as the light-condensing portion 121. The deleted region in the convex portion is, for example, a deleted region extending in the length direction Y in the cross section taken in the thickness direction. The lens main body 110 also is referred to as a lenticular lens, for example.

The size ratio between the light-condensing portion 121 and the non-light-condensing portion 122 in the lens unit 111 is not particularly limited. In the width direction X, the ratio (C:NC) between the width (C) of the light-condensing portion 121 and the width (NC) of the non-light-condensing portion 122 is, for example, 1:1 to 3:1 or 1:1 to 2:1. The length of the lens unit 111 in the width direction X, i.e., the width (W1) in FIG. 1B is, for example, 1000 μm, 500 μm, or 370 μm.

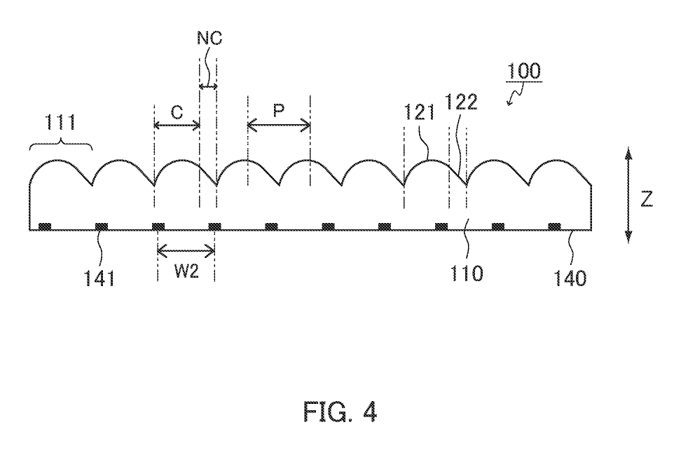

In FIG. 1B, the ratio (C:NC) between the width (C) of the light-condensing portion 121 and the width (NC) of the non-light-condensing portion 122 in the lens unit 111 is, for example, 1:1. The present invention is not limited to this example. FIG. 4 shows an example of the marker of the present invention with the ratio different from the above-described ratio. In the marker 100 shown in FIG. 4, the ratio (C:NC) between the width (C) of the light-condensing portion 121 and the width (NC) of the non-light-condensing portion 122 is 7:3, for example. The marker 100 shown in FIG. 4 is the same as the marker shown in FIG. 1B except for the above-described ratio (C:NC).

The respective lens units 111 constituting the lens main body 110 have the same surface shape and the same size on one surface side (upper surface side) of the lens main body 110, for example. Specifically, it is preferable that the respective lens units 111 have, for example, the light-condensing portions 121 with the same shape and the non-light-condensing portions 122 with the same shape in the same directions, respectively. In the present invention, the meaning of the term “same” encompasses, for example, not only exactly the same but also substantially the same as long as an equivalent function is exhibited.

The lens main body 110 may be formed by connecting a plurality of separately prepared lens units 111 or may be an integrally molded article of the plurality of lens units 111, for example. The lens main body 110 is, for example, an injection molded article. In particular, when the lens main body 110 is the above-described integrally molded article, it is preferable that the lens main body 110 is an injection molded article. In the lens main body 110, it is preferable that the plurality of lens units 111 are connected to each other tightly with no gap between adjacent lens units 111.

The lens main body 110 is, for example, a light-transmitting member. The light-transmitting member is not particularly limited, and may be formed of a resin, glass, or the like, for example. The resin may be, for example, an acrylic resin such as a polycarbonate and polymethyl methacrylate (PMMA), a cycloolefin polymer (COP), a cycloolefin copolymer (COC), or the like.

The size of the lens main body 110 is not particularly limited, and can be determined as appropriate depending on the number of the lens units 111, the intended use of the marker 100, and the like, for example. The size of the lens main body 110 may be such that, for example, the length in the width direction X (i.e., the width) is, for example, 110 mm or 20 mm, the length in the length direction Y is, for example, 25 mm or 5 mm, and the length in the thickness direction Z (i.e., the thickness) is, for example, 1 mm, 0.6 mm, or 1.7 mm.

Although FIGS. 1A and 1B shows an example where the number of the lens units 111 in the lens main body 110 is nine, this example is merely illustrative and the present invention is not limited to this illustrative example. The number of the lens units 111 in the lens main body 110 is not particularly limited, and may be, for example, 221, 101, or 51.

The size of the lens unit 111 is not particularly limited, and can be determined as appropriate depending on the number of the lens units 111 in the marker 100, the intended use of the marker 100, and the like, for example. In the lens unit 111, the length in the width direction X, i.e., the width W1 in FIG. 1B, is, for example, 1000 μm, 500 μm, or 370 μm, as described above. In the lens unit 111, the length in the length direction Y is, for example, 25 mm or 5 mm. In the lens unit 111, the overall length in the thickness direction Z (i.e., the thickness) is, for example, 1 mm or 0.6 mm.

In the present invention, the “pitch of the plurality of lens units” means the pitch P between adjacent lens units. In the plurality of lens units, the pitch between each adjacent pair of lens units may be uniform or nonuniform, and preferably is uniform. In the present invention, the “pitch of the plurality of lens units” in the arrangement direction is different from the “pitch of the plurality of detectable portions” in the arrangement direction.

In the present invention, the “pitch P between adjacent lens units” is, for example, the distance between apexes (the distance between ridge lines) of light-condensing portions 121 of adjacent lens units 111. The apex of the light-condensing portion 121 is, for example, the highest position in the thickness direction, and the ridge line of the light-condensing portion 121 is, for example, a straight line that is located at the highest position in the cross section taken in the thickness direction and extends in the length direction Y. The pitch P between the adjacent lens units 111 is, for example, the same as the width W1 of the lens unit 111.

As described above, the lens main body 110 includes a plurality of detectable portions 141 on the other surface side of the lens main body 110, i.e., on the side of a surface located downward (lower surface) in FIG. 1B. In FIG. 1B, the detectable portions 141 are lines that extend along the length direction Y of the lens main body 110, and a stripe pattern is formed by the plurality of lines. The plurality of detectable portions 141 are projected on the upper surface side of the lens main body 110 as optically detectable images and can be detected optically, for example.

The width W3 of the detectable portion 141 in the width direction X is not particularly limited, and is, for example, 50 μm, 45 μm, or 30 μm. The width of the detectable portion 141 can be determined as appropriate depending on the pitch P between adjacent lens units 111, for example. The ratio between the width W3 of the detectable portion 141 and the width P of the pitch between the lens units 111 is, for example, 1:200 to 1:5. By setting the width W3 of the detected part 141 so as to be relatively larger than the pitch P between the lens units 111, detected images can have relatively higher contrast, for example. On the other hand, by setting the width W3 of the detected part 141 so as to be relatively smaller than the pitch P between the lens units 111, the detectable portions can be detected with further improved sensitivity, for example.

In the present invention, the “pitch of the plurality of detectable portions” means the pitch W2 between adjacent detectable portions. In the plurality of detectable portions, the pitch between each adjacent pair of detectable portions may be uniform or nonuniform, and preferably is uniform. In the present invention, the “pitch of the plurality of detectable portions” is different from the “pitch of the plurality of lens units”.

In the present invention, the “pitch between adjacent detectable portions” is, for example, the distance W2 between the centers of the adjacent detectable portions 141 in the width direction X. The center of the detectable portion 141 is, for example, a midpoint in the width direction X and also a midpoint in the length direction Y.

As described above, the distance W2 between the adjacent detectable portions 141 is different from the width W1 of the lens unit 111. The distance W2 between the adjacent detectable portions 141 may be shorter than the width W1 of the lens unit 111 as shown in FIG. 1B, or may be longer than the width W1 of the lens unit 111, for example.

The detectable portion 141 need only be optically detectable, and may be a colored film, for example. The color of the colored film is not particularly limited, and may be black, for example. The colored film may be, for example, a coating film, and can be formed of a coating material. The coating material is not particularly limited, and may be a liquid coating material or a powder coating material, for example. The coating film can be formed by coating and/or solidifying the coating material, for example. The coating method may be, for example, spray coating, screen printing, or the like. The solidifying method may be, for example, drying of the liquid coating material, curing of a curable component (e.g., a radical polymerizable compound or the like) in the coating material, baking of the powder coating material, or the like.

The detectable portions 141 may be arranged such that, for example, they are located on the inner side of the lens main body 110 relative to the exposed surface of the other surface (lower surface) 140 of the lens main body 110 or they protrude to the outside from the lens main body 110. In the former case, for example, the other surface 140 of the lens main body 110 may have recesses, and the colored films may be arranged in the recesses. In the latter case, for example, the other surface 140 of the lens main body 100 may be flat, and the colored films may be arranged (laminated) on the flat surface. Also, in the latter case, for example, the other surface 140 of the lens main body 100 may have protrusions, and the colored films may be arranged (laminated) on protruding leading end portions of the protrusions.

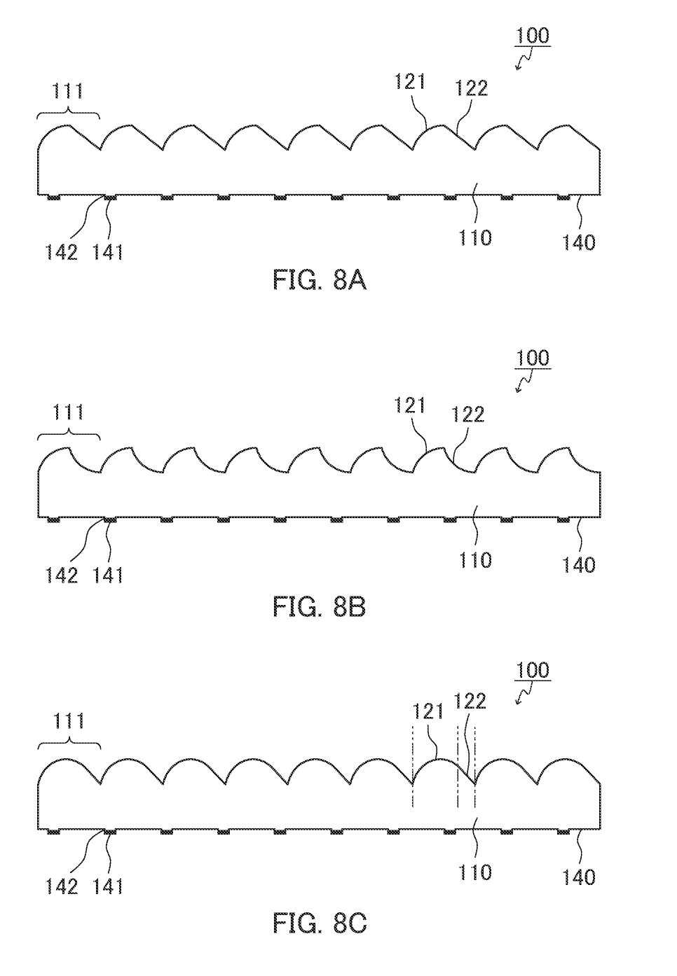

The cross-sectional views of FIGS. 1B, 3, and 4 described above are all directed to examples where the other surfaces (lower surfaces) 140 of the lens main body 100 have recesses and the colored films or the like are arranged in the recesses to form the detectable portions 141. The cross-sectional views of FIGS. 8A to 8C show examples where the other surfaces of the lens main body 100 have protrusions, and the colored films or the like are arranged on the protruding leading end portions of the protrusions to form the detectable portions. The markers shown in FIGS. 8A to 8C are the same as the markers shown in FIGS. 1B, 3 and 4, respectively, except that the other surface 140 of the lens main body 110 have protrusions 142 and the detectable portions 141 are provided on the protrusions 142.

The detectable portions 141 need only be optically distinguishable, for example. The term “optically distinguishable” means that, for example, the detectable portions 141 can be detected with an optically significant difference as compared with regions other than the detectable portions 141. The term “optically significant difference” means that, for example, there is a significant difference with regard to optical characteristics. Examples of the optical characteristics include color properties such as lightness, saturation, and hue and the intensity of light such as luminance. The optically significant difference may be, for example, a difference that can be identified by visual observation or a difference that can be identified by an optical detection device such as a camera. When the detectable portions 141 emit fluorescence, for example, the optically significant difference may be a difference that can be identified by an operation such as light irradiation using a UV lamp.

The pattern formed by the detectable portions 141 is by no means limited. For example, when the pattern is the above-described stripe pattern, the density of the color forming the stripe pattern may be uniform, or the stripe pattern may contain color gradations, for example.

When the marker 100 is placed on, e.g., a white object, among light rays that have entered from the upper surface of the lens main body 110 of the marker 100, the light rays that have reached the detectable portions 141 are absorbed by the detectable portions 141 (e.g., black colored films), and the other light rays pass through the lens main body 110 and are reflected from the surface of the object. Accordingly, on the upper surface of the lens main body 110, images of the detectable portions 141 (e.g., black lines) are projected onto a white background.

The marker of the present invention need only be configured such that, as described above, each of the lens units has the light-condensing portion and the non-light-condensing portion in the state where the pitch of the lens units is different from the pitch of the detectable portions, and the size of each portion is not particularly limited. In the marker of the present invention, the size of each portion can be set as appropriate by, for example, setting the size of the lens unit. Although the size of the marker of the present invention is described in the following by way of example, this is merely is an illustrative example and the present invention is not limited thereto.

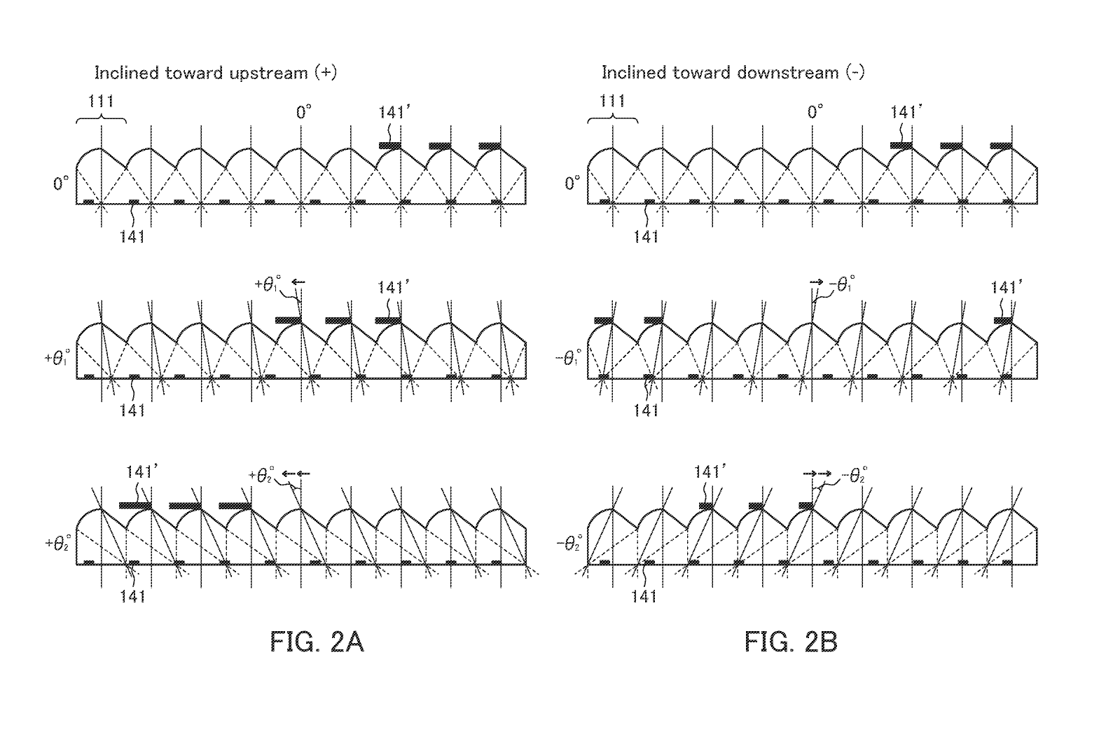

Next, images that change with inclination of light rays (viewing direction) at positive angles and images that change with inclination of light rays at negative angles in the case where the marker of the present invention shown in FIGS. 1A and 1B is used will be described with reference to FIGS. 2A and 2B. In FIGS. 2A and 2B, the marker is the marker 100 shown in FIGS. 1A and 1B.

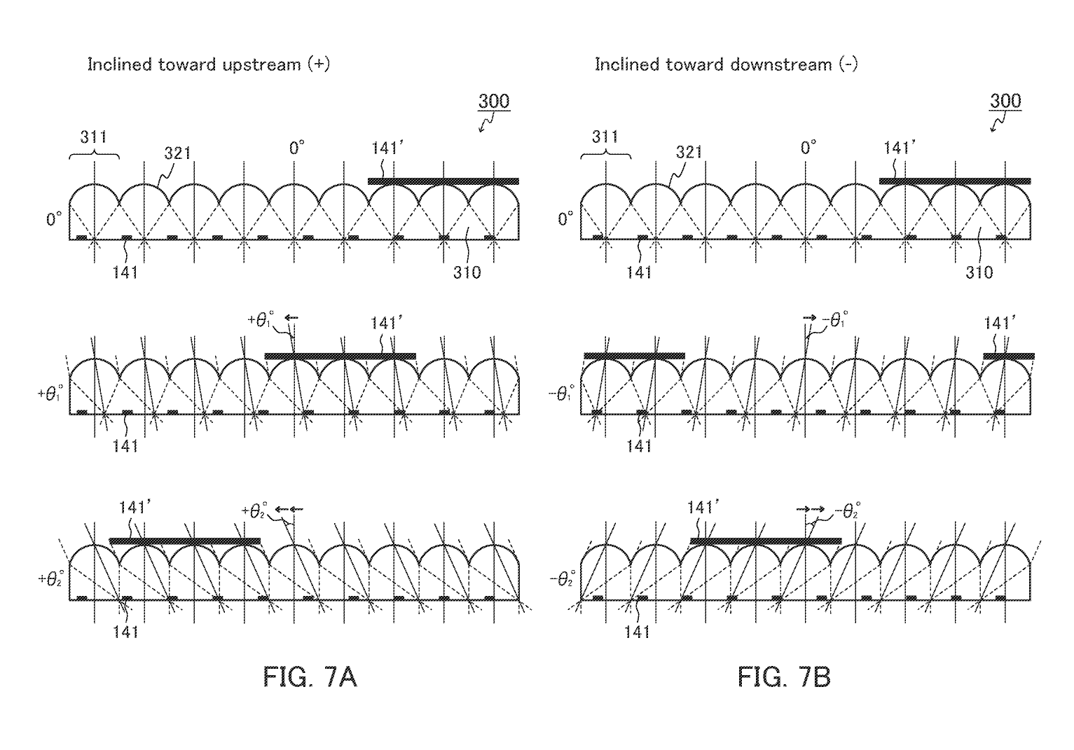

First, for comparison with the present invention, a conventional marker in which lens units each having a convex light-condensing portion and not having a non-light-condensing portion are arranged successively will be described with reference to FIGS. 7A and 7B. FIGS. 7A and 7B are cross-sectional views showing a conventional marker 300. The marker 300 includes a lens main body 310 including a plurality of lens units 311, and the plurality of lens units 311 are arranged successively in a planar direction (width direction). The surface of each of the lens unit 311 does not have a non-light-condensing portion and has a convex portion serving as a light-condensing portion 321. The marker 300 is the same as the marker 100 shown in FIGS. 1A and 1B, except that the surface of each of the lens units 311 does not have a non-light-condensing portion and has a light-condensing portion 321. That is, for example, the conditions of the detection target units 141, the conditions of the lens units as a whole, etc. are the same as those in the marker 100.

In each of FIGS. 7A and 7B, a solid line that intersects the lens main body 310 at right angles is the normal line (0°). In FIGS. 7A and 7B, for the sake of convenience, inclination toward the upstream side in the width direction X is explained as inclination at positive angles, and inclination toward the downstream side in the width direction X is explained as inclination at negative angles.

When light enters from the upper surface of the lens main body 310 of the marker 300, the light converges from the light-condensing portion 321, and if the detection target unit 141 is present at the focal point, the image of the detection target unit 141 is projected onto the upper surface of the lens main body 310.

FIG. 7A shows cross-sectional views showing how images projected on the lens main body 310 change when light rays incident on the marker 300 are inclined at positive angles from the normal line (0°). In FIG. 7A, the cross-sectional view in the first row is a cross-sectional view showing the state where inclination of light rays is the same as the normal line, i.e., the inclination angle is 0°, the cross-sectional view in the second row is a cross-sectional view showing the state where the light rays are inclined at a positive inclination angle (+θ₁°) from the normal line, and the cross-sectional view in the third row is a cross-sectional view showing the state where the light rays are inclined at a greater positive inclination angle (+θ₂°, +θ₂°>+θ₁°) from the normal line.

As shown in the first row (0°), when the inclination angle is 0°, the seventh, eighth, and ninth lens units from the upstream side satisfy the above-described conditions under which an image is projected, and three images are projected in a continuous state on these lens units. As shown in the second row (+θ₁°), when the light rays are inclined in the arrow direction at the positive inclination angle, the fifth, sixth, and seventh lens units, which are located further upstream as compared with the case where the inclination angle is 0°, satisfy the above-described conditions under which an image is projected, and three images are projected in a continuous state on these lens units. Furthermore, as shown in the third row (+θ₂°), when the light rays are inclined at an inclination angle greater than that in the second row, the second, third, and fourth lens units, which are located further upstream as compared with the case where the inclination angle is +θ₁°, satisfy the above-described conditions under which an image is projected, and three images are projected in a continuous state on these lens units. From these drawings, it can be seen that, as an angle of inclination toward the positive direction increases, a projected image moves to the upstream side while maintaining the same width.

On the other hand, FIG. 7B shows cross-sectional views showing how images projected on the lens main body 310 change when light rays incident on the marker 300 are inclined at negative angles from the normal line (0°). In FIG. 7B, the cross-sectional view in the first row is the same as that in FIG. 7A, and shows the state where inclination of light rays is the same as the normal line, i.e., the inclination angle is 0°, the cross-sectional view in the second row is a cross-sectional view showing the state where the light rays are inclined at a negative inclination angle (−θ₁°) from the normal line, and the cross-sectional view in the third row is a cross-sectional view showing the state where the light rays are inclined at a greater negative inclination angle (−θ₂°, |−θ₂|>|−θ₁|) from the normal line.

As shown in the first row (0°), when the inclination angle is 0°, three images are projected in a continuous state on the seventh, eighth, and ninth lens units from the upstream side, as described above. As shown in the second row (−θ₁°), when the light rays are inclined in the arrow direction at a negative inclination angle, unlike the case where the inclination angle is 0°, the first, second, and ninth lens units from the upstream side satisfy the above-described conditions under which an image is projected, and the images are projected on these lens units. As the inclination angle shown in the first row (0°) increases to the inclination angle shown in the second row (−θ₁°), the images move to the downstream side, and once the images reach the downstream end, a new image appears from the upstream side again. Accordingly, in the second row (−θ₁°), one image is projected on the ninth lens unit, and two images are projected in a continuous state on the first and second lens units. Furthermore, as shown in the third row (−θ₂°), when the light rays are inclined at an inclination angle greater than that in the second row, unlike the case where the inclination angle is −θ₁°, the third, fourth, and fifth lens units from the upstream side satisfy the above-described conditions under which an image is projected, and three images are projected in a continuous state on these lens units. From these drawings, it can be seen that, as an angle of inclination toward the negative direction increases, a projected image moves to the downstream side while maintaining the same width and then further appears from the upstream side.

Next, the images obtained in the case of positive angle inclination as shown in FIG. 7A are compared with the images obtained in the case of negative angle inclination as shown in FIG. 7B. In both the former and latter cases, an image with the same width appears on the surface of the lens main body 310, and the image moves from the downstream side to the upstream side or from the upstream side to the downstream side with the width thereof remaining unchanged. Accordingly, in the cases of positive angle inclination and negative angle inclination, there are cases where images appear at the same position, and besides, these images have the same width. Therefore, it is difficult to determine whether an image at a certain position is an image resulting from inclination at a positive angle or a negative angle.

Next, the marker according to the present invention will be described with reference to FIGS. 2A and 2B. In each of FIGS. 2A and 2B, a solid line that intersects the lens main body 110 at right angles is the normal line (0°). In FIGS. 2A and 2B, for the sake of convenience, inclination toward the upstream side in the width direction X is explained as inclination at positive angles, and inclination toward the downstream side in the width direction X is explained as inclination at negative angles.

When light enters from the upper surface of the lens main body 110 of the marker 100, the light converges from the light-condensing portion 121, and if the detection target unit 141 is present at the focal point, the image of the detection target unit 141 is projected onto the upper surface of the lens main body 110.

FIG. 2A shows cross-sectional views showing how images projected on the lens main body 110 change when light rays incident on the marker 100 are inclined at positive angles from the normal line (0°). In FIG. 2A, the cross-sectional view in the first row is a cross-sectional view showing the state where inclination of light rays is the same as the normal line, i.e., the inclination angle is 0°, the cross-sectional view in the second row is a cross-sectional view showing the state where the light rays are inclined at a positive inclination angle (+θ₁°) from the normal line, and the cross-sectional view in the third row is a cross-sectional view showing the state where the light rays are inclined at a greater positive inclination angle (+θ₂°, +θ₂°>+θ₁°) from the normal line.

As shown in the first row (0°), when the inclination angle is 0°, the seventh, eighth, and ninth lens units from the upstream side satisfy the above-described conditions under which an image is projected, and three images are projected in a discrete state on these lens units. As shown in the second row (+θ₁°), when the light rays are inclined in the arrow direction at the positive inclination angle, the fifth, sixth, and seventh lens units, which are located further upstream as compared with the case where the inclination angle is 0°, satisfy the above-described conditions under which an image is projected, and three images are projected in a discrete state on these lens units. Furthermore, as shown in the third row (+θ₂°), when the light rays are inclined at an inclination angle greater than that in the second row, the second, third, and fourth lens units, which are located further upstream as compared with the case where the inclination angle is +θ₁°, satisfy the above-described conditions under which an image is projected, and three images are projected in a discrete state on these lens units. From these drawings, it can be seen that a projected image moves as an angle of inclination toward the positive direction increases.

On the other hand, FIG. 2B shows cross-sectional views showing how images projected on the lens main body 110 change when light rays incident on the marker 100 are inclined at negative angles from the normal line (0°). In FIG. 2B, the cross-sectional view in the first row is the same as that in FIG. 2A, and shows the state where inclination of light rays is the same as the normal line, i.e., the inclination angle is 0°, the cross-sectional view in the second row is a cross-sectional view showing the state where the light rays are inclined at a negative inclination angle (−θ₁°) from the normal line, and the cross-sectional view in the third row is a cross-sectional view showing the state where the light rays are inclined at a greater negative inclination angle (−θ₂°, |−θ₂|>|−θ₁°|) from the normal line.

As shown in the first row (0°), when the inclination angle is 0°, three images are projected in a discrete state on the seventh, eighth, and ninth lens units from the upstream side, as described above. As shown in the second row (−θ₁°), when the light rays are inclined in the arrow direction at a negative inclination angle, unlike the case where the inclination angle is 0°, the first, second, and ninth lens units from the upstream side satisfy the above-described conditions under which an image is projected, and the images are projected in a discrete state on these lens units. As the inclination angle shown in the first row (0°) increases to the inclination angle shown in the second row (−θ₁°), the images move to the downstream side, and once the images reach the downstream end, a new image appears from the upstream side again. Accordingly, in the second row (−θ₁°), one image is projected on the ninth lens unit, and two images are projected in a discrete state on the first and second lens units. Furthermore, as shown in the third row (−θ₂°), when the light rays are inclined at an inclination angle greater than that in the second row, unlike the case where the inclination angle is −θ₁°, the third, fourth, and fifth lens units from the upstream side satisfy the above-described conditions under which an image is projected, and images are projected in a discrete state on these lens units. From these drawings, it can be seen that, as an angle of inclination toward the negative direction increases, discrete projected images move to the downstream side and then further appear from the upstream side.

Next, the images obtained in the case of positive angle inclination as shown in FIG. 2A are compared with the images obtained in the case of negative angle inclination as shown in FIG. 2B. The inclination angle in the second row (+θ₁°) in FIG. 2A and the inclination angle in the second row (−θ₁°) in FIG. 2B have the same absolute value (|θ₁|°). Also, the inclination angle in the third row (+θ₂°) in FIG. 2A and the inclination angle in the third row (−θ₂°) in FIG. 2B have the same absolute value (|θ₂|°). However, the widths of the images resulting from the inclination at the negative inclination angle (−θ₁°) are narrower than the widths of the images resulting from the inclination at the positive inclination angle (+θ₁′). Furthermore, the widths of the images resulting from the inclination at the negative inclination angle (−θ₂°) were considerably narrower than the widths of the images resulting from the inclination at the positive inclination angle (+θ₂°), and the widths of the images resulting from the inclination at the negative inclination angle (−θ₂°) are only about ⅓ of the widths of the images resulting from the inclination at the positive inclination angle (+θ₂°).

In the marker 100 according to the present embodiment, in the cases of inclination at positive angles and inclination at negative angles, projected images move to the upstream side or to the downstream side, as in the case of the conventional marker 300. However, in the marker 100 of the present embodiment, the widths of the images resulting from inclination at positive inclination angles are totally different from the widths of the images resulting from inclination at negative inclination angles, unlike the case of the conventional marker 300. Specifically, in the marker 100, for example, as an angle of inclination toward the negative direction increases, the widths of images become narrower as compared with the widths of images obtained when the inclination angle is 0°, and as an angle of inclination toward the positive direction increases, the widths of images become broader as compared with the widths of the images obtained when the inclination angle is 0°. As the widths of the images become relatively broader, for example, the optical characteristics as described above become more significant and the contrast becomes higher in detection. Accordingly, in the marker 100, even if images are projected at the same position in the cases of inclination at a positive angle and inclination at a negative angle, the width of the images are totally different between these cases. Therefore, it is possible to determine whether the projected images are projected images resulting from inclination at a positive angle or inclination at a negative angle. That is, it can be said that, according to the marker 100 of the present embodiment, it is possible to determine the direction of inclination of light rays and optionally the inclination angle on the basis of the positions of the projected images, the optical characteristics, and the like.

As described above, according to the marker of the present invention, in the cases of inclination at positive angles and inclination at negative angles, it is possible to determine the direction of light rays (viewing direction) from the images obtained in each case, for example. The reason for this is that, for example, there is an optically significant difference between image detection from one direction and image detection from a direction opposite thereto. Thus, the marker of the present invention is able to detect images in one direction more significantly than in the opposite direction, rather than being able to detect images similarly in both one direction and the opposite direction. Accordingly, the marker of the present invention also can be referred to as a unidirectional visual marker, for example. As described above, the unidirectional visibility does not mean that visibility in the opposite direction cannot be achieved.

### Second Embodiment

The second embodiment relates to an example of a marker set of the present invention including a marker of the present invention and a two-dimensional pattern code.

The marker set further includes, for example, a substrate, and the two-dimensional pattern code and the marker are arranged on the substrate. Also, the marker set may be configured such that, for example, it includes at least two markers, and at least one marker is the above-described unidirectional visual marker and at least one other marker is a bidirectional visual marker. In the marker set, the two-dimensional pattern code is an AR marker, for example.

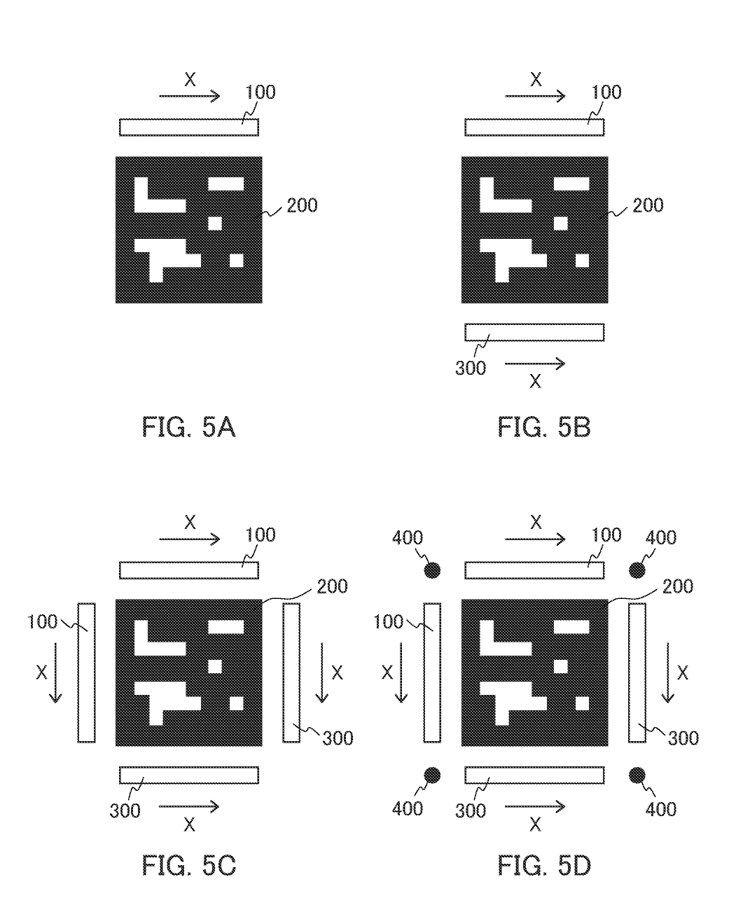

FIGS. 5A to 5D show specific examples of the marker set of the present embodiment.

FIG. 5A is a plan view of the marker set including the marker 100 of the first embodiment shown in FIGS. 1A and 1B and a two-dimensional pattern code. In FIG. 5A, arrow X indicates the same width direction X as in FIGS. 1A and 1B, and the arrowhead indicates a direction from the upstream side to the downstream side.

The two-dimensional pattern code is not particularly limited, and may be, for example, an AR marker, a QR marker, or the like. Examples of the AR marker include ARToolKit, ARTag, CyberCode, and ARToolKit Plus.

According to the marker set shown in FIG. 5A, the direction and angle of inclination of light rays (viewing direction) can be determined by detecting the markers 100 together with the AR marker.

FIG. 5B is a plan view of a marker set configured such that the marker set shown in FIG. 5A further includes a bidirectional visual marker 300 for the unidirectional visual marker 100. The unidirectional visual marker 100 and the bidirectional visual marker 300 are arranged so that their width directions X extending from the upstream side to the downstream side are parallel with each other.

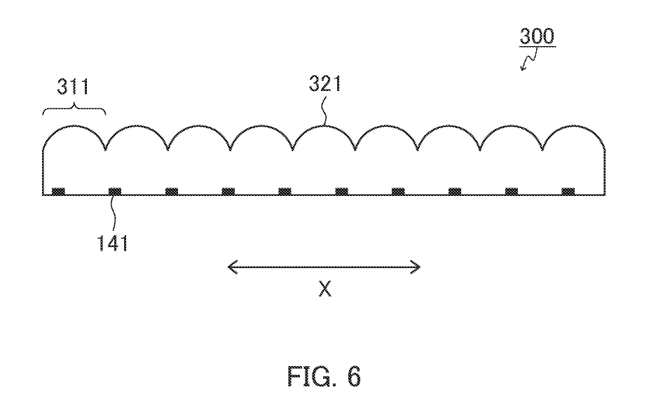

An example of the bidirectional visual marker 300 is shown in the cross-sectional view of FIG. 6. The marker 300 shown in FIG. 6 is the same as the unidirectional visual marker 100, except that the surface of each lens unit 311 does not have a non-light-condensing portion and has a convex portion serving as a light-condensing portion 321. That is, for example, the conditions of detection target units 141, the conditions of the lens units 311 as a whole, etc. are the same as those in the marker 100. Also, the marker 300 may be configured such that, for example, similarly to the unidirectional visual marker 100 shown in FIG. 8, a lower surface thereof has protrusions, and colored films or the like are arranged on protruding leading end portions of the protrusions to form the detectable portions 141.

In the marker set shown in FIG. 5B, the unidirectional visual marker 100 and the bidirectional visual marker 300 are arranged in parallel so as to extend in the same direction. As described above, the unidirectional visual marker 100 is configured so as to include the non-light-condensing portions 122, and with this configuration, it is possible to determine whether the light rays are inclined at a positive angle or a negative angle from the obtained images. Therefore, regarding to the above-described marker set, by detecting the unidirectional visual marker 100 and the bidirectional visual marker 300, it can be determined that, for example, light rays are inclined at a positive angle when the same images are detected from both the markers and that light rays are inclined at a negative angle when different images are detected from these markers.

In FIG. 5B, the marker 100 and the marker 300 are arranged with the two-dimensional pattern code 200 interposed therebetween. It is to be noted, however, that the present invention is not limited thereto. For example, both the marker 100 and the marker 300 may be arranged in parallel with each other on either side of the two-dimensional pattern code 200.

FIG. 5C is a plan view of a marker set configured such that the marker set shown in FIG. 5B further includes another pair of an unidirectional visual marker 100 and a bidirectional visual marker 300 for the unidirectional visual marker 100.

According to the marker set shown in FIG. 5C, for example, it is possible to determine, with respect to the plane of the paper of FIG. 5C, not only inclination in the vertical direction but also inclination in the horizontal direction.

FIG. 5D is a plan view of a marker set configured such that the marker set shown in FIG. 5D further includes indications (marks) 400 for specifying detection positions at four corners.

According to the marker set shown in FIG. 5D, a region to be detected can be specified easily with reference to the marks 400, for example. When the detection method is a method using an optical device such as a camera, by detecting the marks 400, for example, a region bounded by the marks 400 at the four corners can be specified as a region to be detected.

This application claims priority from Japanese Patent Application No. 2016-210979 filed on Oct. 27, 2016. The entire disclosure of this Japanese patent application is incorporated herein by reference.

### INDUSTRIAL APPLICABILITY

As specifically described above, the marker according to the present invention is configured such that each of the lens units includes the light-condensing portion and the non-light-condensing portion, and with this configuration, it is possible to determine, for example, whether the viewing direction is inclined at a positive angle relative to the normal line or inclined at a negative angle relative to the normal line. The use of the marker of the present invention is not particularly limited. For example, the marker of the present invention can be used widely in the fields of AR and robotics for the purpose of recognizing the position, posture, and the like of an object.

### REFERENCE SIGNS LIST

100: marker
110, 310: lens main body
111,311: lens unit
121, 321: light-condensing portion
122: non-light-condensing portion
141: detectable portion
141′: image
142: convex portion
200: two-dimensional pattern code
300 bidirectional visual marker

1. A marker comprising:
a lens main body comprising a plurality of lens units,
wherein the plurality of lens units are arranged successively in a planar direction,
each of the lens units comprises, on one surface side of the lens main body, a light-condensing portion and a non-light-condensing portion that are provided along an arrangement direction in which the lens units are arranged successively,
the lens main body comprises, on the other surface side of the lens main body, a plurality of detectable portions that can be detected from the one surface side, and
a pitch of the plurality of lens units is different from a pitch of the plurality of detectable portions.

2. The marker according to claim 1, wherein
in each of the lens units, the light-condensing portion has a convex surface and the non-light-condensing portion has a planar or concave surface.

3. The marker according to claim 1, wherein
each of the lens units is a partially deleted cylindrical lens that is a cylindrical lens with part of a convex portion thereof being deleted, and
the deleted region in the convex portion is the non-light-condensing portion, and a remaining region in the convex portion is the light-condensing portion.

4. The marker according to claim 1, wherein
a cross section of each of the lens units taken in a thickness direction is such that a ratio (C:NC) between a length (C) of the light-condensing portion in the arrangement direction and a length (NC) of the non-light-condensing portion in the arrangement direction in 1:1 to 3:1.

5. The marker according to claim 1, wherein
the lens main body has a plurality of recesses on the other surface side of the lens main body, and
the detectable portions are provided inside the respective recesses.

6. The marker according to claim 1, wherein
the lens main body is an integrally molded article of the plurality of lens units.

7. The marker according to claim 1, wherein
the lens main body is an injection molded article.
